(19) United States
(12) Patent Application Publication
(10) Pub. No.: US 2007/0162209 A1
(43) Pub. Date: Jul. 12, 2007

(54) Control mechanism for a sprinkling system

(76) Inventor: Johann Gallaun, Soding (AU)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/556,815

(22) PCT Filed: May 19, 2004
(86) PCT No.: PCT/AT04/00177

§ 371 Date: Nov. 9, 2005

(30) Foreign Application Priority Data
Jun. 25, 2003 (AT) A 977/2003

(51) Int. Cl. G06F 7/70

(52) U.S. Cl. 701/50; 239/731; 239/733; 701/33; 701/36

(57) ABSTRACT

This invention concerns a control for a spray irrigation system consisting of pipelines that are coupled with each other and are carried by mobile towers, whereby associated with each mobile tower is a drive motor and an electrical control unit as well as a sensor connected to the control unit for determining the relative position to the neighboring mobile towers.

It is characterized by the fact that the spray irrigation system has a central control unit (2) that communicates with control units (7) associated with the mobile towers (3, 4, 5, 6), which transmit signals, in particular data regarding the relative positions of the mobile towers (3, 4, 5, 6), to the control unit (2) or that respectively receive instructions from the central control unit (2) and execute them.

The object of this invention is a corrective control for a spray irrigation system consisting of pipelines that are coupled to each other and carried by mobile towers, and which are moved at right angles to the pipe axis. The motion also can occur such that one point of the pipeline is fixed, with the pipeline moving around this point in a circle. Such systems are known under the designation CENTER PIVOT or LINEAR-MOVE SYSTEMS. They are usually driven by electric motors that are mounted on the individual mobile towers. The linear orientation of these systems is achieved by switching the individual motors on and off.

For this control of the drive motors, it is necessary for the deviation of the respective mobile tower from the ideal linear orientation to be measured by sensors (transfer component, switch cam). Electromechanical switching components (microswitch, contactor) are then actuated via these sensing devices.

This is accomplished as follows in conventional systems:

Located on each mobile tower is an electrical control unit, which is connected via a supply cable with the central switch cabinet (central control), which is usually situated at the point of rotation of the system. The main circuit for the drive motors and the control voltage for the control units are carried by this cable. The principal parts of the central control are a transformer for the control voltage, a main switch which supplies electricity to the system, a switch for forward and reverse operation of the system, a percentage timer for regulating the speed of the last mobile tower and a switch, which sets the system in motion and stops it.

Since the speed of each drive motor is fixed, each mobile tower will run at the same speed when the system is set in motion. However, in the case of CENTER PIVOT systems, the innermost mobile tower must travel a proportionally shorter distance in order to perform a 360° turn. Therefore, the innermost mobile tower must run for a proportionally shorter time interval in order to hold the system straight. As previously mentioned, the percentage timer, which fixes the speed of the system, is built into the central control. If it is set to 100%, the contactor of the drive motor of the last mobile tower closes, whereby 400 V are continuously applied to the drive motor and the mobile tower runs constantly. For technical reasons, in spray irrigation it is necessary to allow the system to run at lower speeds, so that the percentage timer is, for example, set to 50%, which means that end tower 1 is, for a period of one minute, in operation for 30 seconds and stationary for 30 seconds. This end tower is also called the control tower. It contains no sensor since no angular deviation of a subsequent mobile tower needs to be registered here.

The inner mobile towers contain a sensor, which transmits the degree of angular deviation between two mobile towers via a transmission component and a switch cam to two microswitches, one of which serves as an operating switch and with the second serving as a safety switch.

If the last mobile tower now moves forward, the transmission component on the next to last mobile tower is also moved forward along with the switch cam; at a certain angular deviation, the switch cam actuates the microswitch, whereon the contactor is closed and the drive motor sets the mobile tower in motion. The latter runs until it is in a linear orientation with respect to the last mobile tower.

This alignment is repeated for each mobile tower over the entire length of the system. Since the final mobile tower stands still only briefly, it can be again set in motion before the inward alignment is complete. Each mobile tower can thus run at any time; it depends only on the angular deviation of the mobile towers with respect to each other. If, due to a defect, a mobile tower lags behind or runs ahead and if the permissible angular deviation is thereby exceeded, the safety switch is actuated, which thereon switches the entire system off (cutoff). The realignment of a system in the cutoff state takes place via the central control and occurs “manually”. This kind of corrective control has the disadvantage that not all mobile towers are centrally controllable from one point, that all mobile tower motors can run at the same time; that, in the case of a cutoff, the cause and the exact location of the error cannot be identified centrally; and the realignment after a cutoff must occur “manually”.

Regarding the known state of the art, the following should also be stated: U.S. Pat. No. 6,045,066 A, U.S. Pat. No. 6,085,999 A, and U.S. Pat. No. 4,569,481 A each disclose an irrigation system with which an efficient irrigation of the corners of a square field can be achieved. Such an irrigation system has an additional irrigation arm, whose deflection with respect to the main arm is detected by computer via a sensor for determining the deflection angle. In order to reach most of the corner areas of a square field, a computer controls the motion of the additional irrigation arm. Preprogrammed sprinkler sequences provide uniform irrigation of the corner areas. The mobile towers, which carry the main arm of the irrigation system, are essentially held in a straight line. No further detail is provided regarding how this alignment of the main arm is achieved. It is only in U.S. Pat. No. 4,569,481 (A) that a suitable alignment system of the type such as that usually provided on center-pivot spray irrigation machines is mentioned. Control units, which sit on the individual mobile towers, as well as a central control unit, which is connected with the individual mobile towers or respectively their control units, are not revealed in the aforesaid document. U.S. Pat. No. 5,246,164 A and WO 00/15987 A1 describe an irrigation system for the controlled irrigation or fertilization of a field with different sections, for example different soil conditions. Such an irrigation system comprises sensors for detecting damp or dry locations, the nature and size of the vegetation or the soil composition. The valves of the individual sprinklers are controlled by a shared control unit, depending on the evaluation of the data thereby received.

U.S. Pat. No. 5,246,164 (A) provides more detailed information about the linear alignment of the main arm. According to this, the outermost mobile tower is the control tower which controls the motion of the remaining mobile towers. Electromechanical devices manage the relative alignment between the mobile towers and set the motor of the respective mobile tower in motion, in order to provide a linear alignment. A central control unit, which centrally manages the alignment of the individual mobile towers with respect to each other and which controls the motors centrally, is not revealed.

The irrigation system of WO 00/15987 (A1) comprises so-called alignment sensors. Electronically controlled motors respond independently to these sensors so as to ensure a linear alignment of the individual units. This irrigation system in fact consists of a control unit, in particular for controlling the sprinklers as well as for data evaluation concerning soil conditions. No indication that the control unit is connected to the alignment sensors is disclosed therein.

It is the object of the present invention to enable central control of all mobile towers from a single point, to determine the maximum number of operating mobile tower motors, to align the mobile towers that are simultaneously in operation, to obtain information from the mobile towers, to transmit information from the central control, to provide for the alignment of the overall system and for the automatic realignment after a cutoff.

This is achieved according to this invention by the spray irrigation system having a central control unit that communicates with the control units associated with the mobile towers, which send status signals—in particular data about the relative positions of the mobile towers—to the central control unit, or that respectively receive instructions from the central control unit and implement them.

This invention is described in greater detail below by means of drawings.

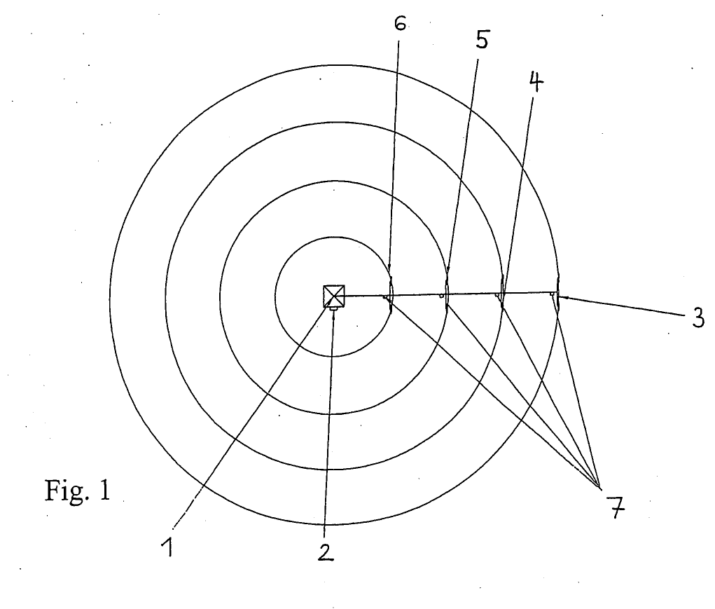

FIG. 1 shows the mobile towers of a spray irrigation system in its initial position,

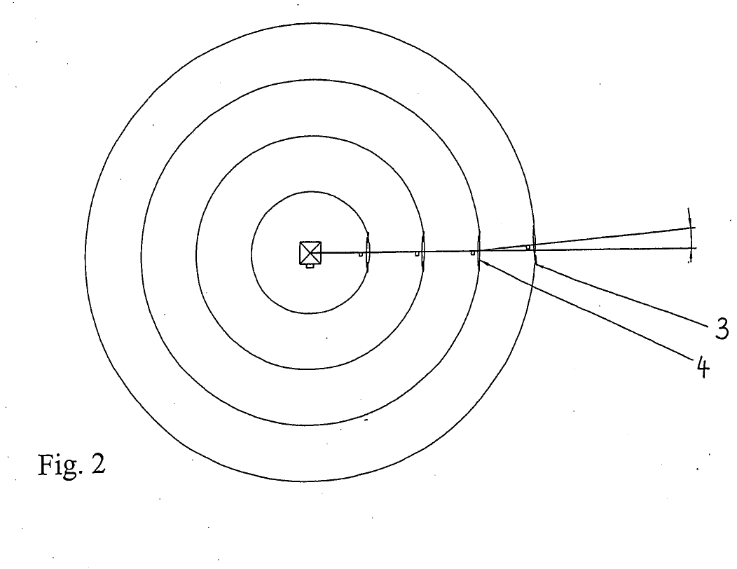

FIG. 2 shows the mobile towers after a movement of the end tower,

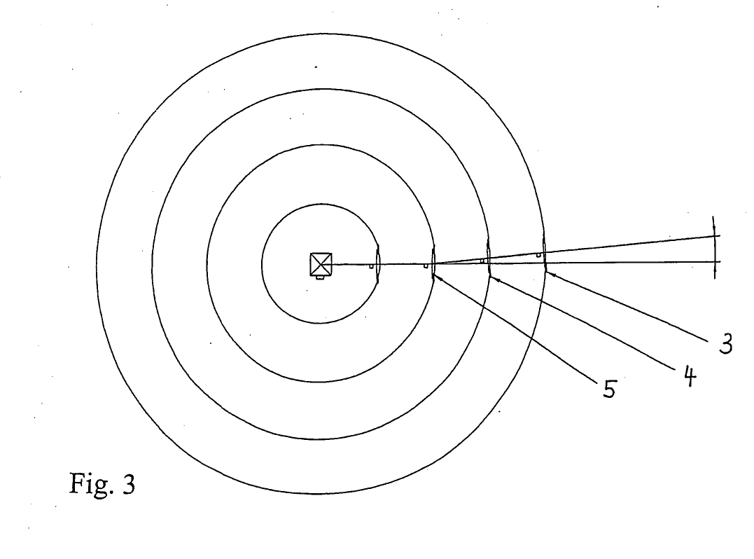

FIG. 3 shows the mobile towers according to FIG. 2 after a movement of the 1^{st} mobile tower,

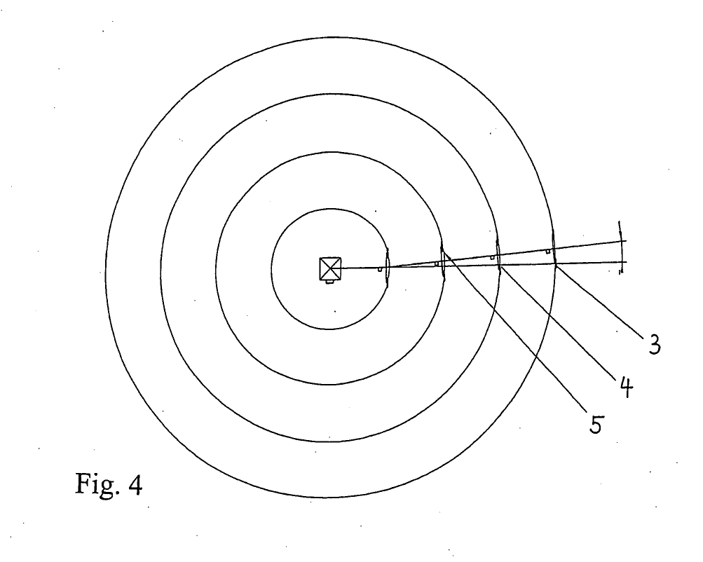

FIG. 4 shows the mobile towers according to FIG. 3 after a movement of the 2^{nd} mobile tower,

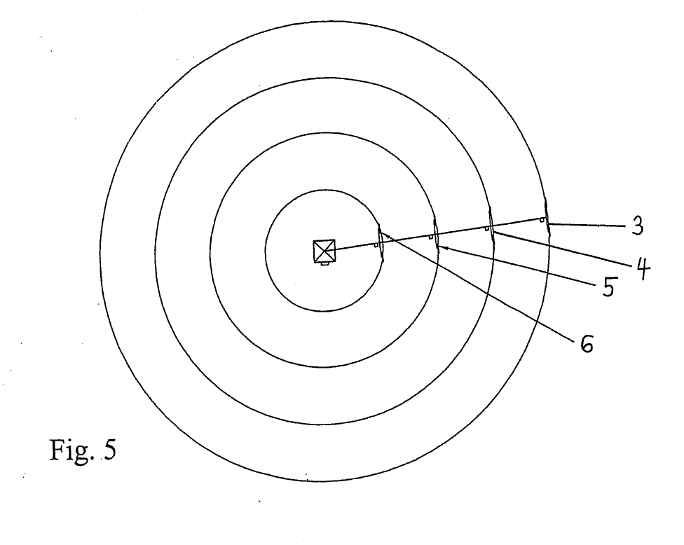

FIG. 5 shows the mobile towers according to FIG. 4 after a movement of the 3^{rd} mobile tower,

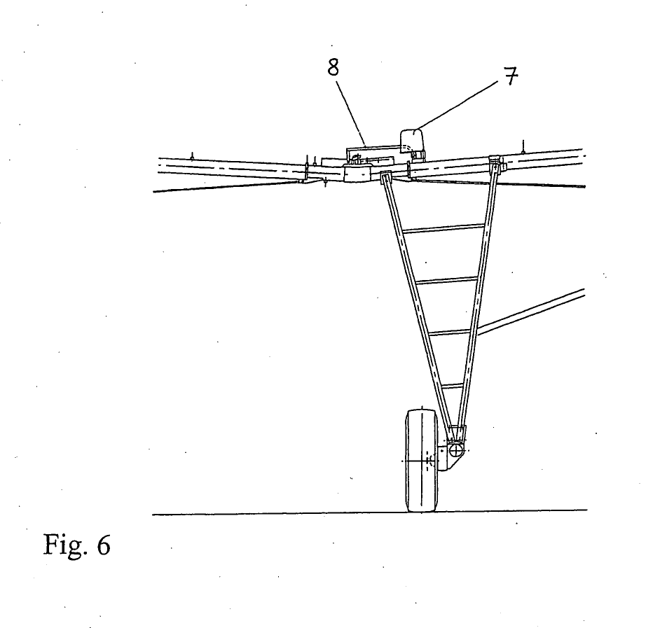

FIG. 6 shows a mobile tower with a sensor and a control unit, and

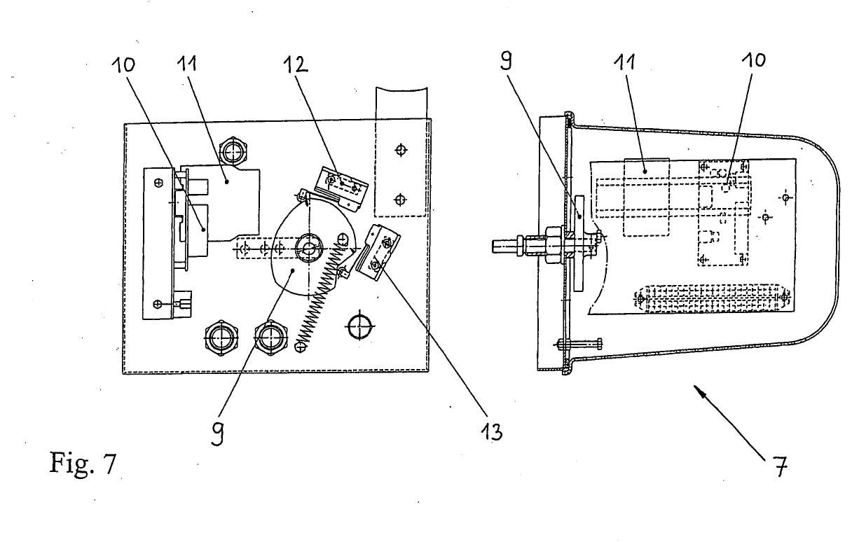

FIG. 7 is an enlarged view of a control unit from two different viewing angles.

FIGS. 1, 2, 3, and 4 show how, starting from of their initial position (FIG. 1), the individual mobile towers 3, 4, 5, 6, starting with the end tower 3 (FIG. 2), successively turn through a certain angle about the central point of rotation 1 of the spray irrigation system. The speed setting on the percentage timer, e.g., 50%, corresponds to a driving speed of 72.5 m/h (max. 145 m/h). The percentage timer operates in a time sequence of one minute, i.e., with a timer setting of 50%, the unit runs for 30 seconds. The last tower 3 runs until, for example, it has achieved a maximum angular movement of 0.15°. With a 58.5-m span, this corresponds to a path length of 153 cm. Thereafter, the first mobile tower 4 runs until a maximum angular movement of 0.15° is achieved (FIG. 3). Thereafter the mobile towers 5, 6 follow, until the final mobile tower 6 is in a linear alignment with respect to the remaining mobile towers 3, 4, 5.

This invention concerns a corrective control for movable-pivot spray irrigation systems, consisting of pipelines that are coupled with one another and are carried by mobile towers 3, 4, 5, 6, where the alignment of these mobile towers with respect to each other is accomplished by means of a control unit 7 that is centrally mounted on the mobile tower. FIG. 6 shows a mobile tower with a control unit 7 and a sensor 8 for determining the relative position of the neighboring mobile towers. Sensor 8 consists of a transmission component and a switch cam 9 connected therewith. FIG. 7 shows a magnified view of the control unit 7 from different viewing angles The control unit consists of a switch cam 9 connected to the sensor 8, microswitches 12, 13 that can be actuated thereby, with switch 12 serving as the operating switch and switch 13 as a safety switch, and a contactor 11. Each of these control units 7 now contains an intelligent control device, which communicates with a central control unit 2 (control central) via the transmission medium CAN-BUS, and sends status signals to it or respectively receives and executes instructions from it. This control is represented in FIG. 7 as CAN node 10. The serial CAN (Controller Area Network) bus system originally developed by Bosch/Intel for automotive applications is capable of multi-tasking, i.e., several CAN participants can address the BUS at the same time. The message with the higher priority (as defined by the identifier) is accepted without a time delay. Each of the control points, subsequently called “CAN nodes”, can thereby be switched ON or OFF by the central control.

The inputs of these CAN nodes are actuated by microswitches 12, 13 and this information is transmitted via the CAN-BUS to the central control 2. Furthermore, information from central control 2 is transferred to CAN node 10 via the CAN-BUS and is delivered to the drive motors or respectively to the indicator lights. The benefits of this system compared with other systems consist of the fact that every CAN node can be centrally controlled. This opens up new possibilities for controlling a CENTER PIVOT, for determining the maximum number of operating mobile towers, and for aligning the mobile towers that are simultaneously put into operation. A new possibility for aligning the entire system with all mobile towers 3, 4, 5, 6 via the central control 2 means that all mobile towers do not exhibit any angular deviation, i.e., that the entire CENTER PIVOT is aligned by the central control 2 in a straight line extending from the center 1 of the system up to the last mobile tower 3.

This is necessary for the normal operation of the CENTER PIVOT, since an angular deviation between two mobile towers which is too large causes shutdown of the CENTER PIVOT, and causes the output of an error signal reporting the cause of the error and the exact position of the error (at which CAN node).

Such information is only obtainable via the CAN node 10 mounted on each mobile tower (FIG. 7), which reports this information to the central control 2.

1. Control for a spray irrigation system consisting of pipelines that are coupled with each other and are carried by mobile towers, whereby associated with each mobile tower is a drive motor and an electrical control unit as well as a sensor connected to the control unit for determining the relative position to the neighboring mobile towers, characterized by the fact that the spray irrigation system has a central control unit (2), which communicates with the control units (7) associated with the mobile towers (3, 4, 5, 6), which transmit status signals, in particular data about the relative positions of the mobile towers (3, 4, 5, 6) to the central control unit (2) or respectively receive instructions from the central control unit (2) and execute them.

2. Control according to claim 1, characterized by the fact that the central control unit (2) communicates with the control units (7) associated with the mobile towers (3, 4, 5, 6) via a CAN (Controller Area Network) serial bus system.
